(19) United States
(12) Patent Application Publication
(10) Pub. No.: US 2017/0218895 A1
(43) Pub. Date: Aug. 3, 2017

(54) A FILTER STRUCTURE FOR FUEL, A CARTRIDGE AND A FILTER GROUP

(71) Applicant: UFI INNOVATION CENTER S.R.L., Ala (TN) (IT)

(72) Inventor: Giorgio GIRONDI, Mantova (IT)

(73) Assignee: UFI INNOVATION CENTER S.R.L., Ala (TN) (IT)

(21) Appl. No.: 15/314,386

(22) PCT Filed: May 26, 2015
(86) PCT No.: PCT/IB2015/000809

§ 371 Date: Nov. 28, 2016

(30) Foreign Application Priority Data
May 29, 2014 (IT) RE2014A000052

(51) Int. Cl. F02M 37/22; B01D 29/56; B01D 29/15; B01D 17/04

(52) U.S. Cl. CPC F02M 37/221; B01D 17/045; B01D 29/56; B01D 29/15; B01D 2239/0428

(57) ABSTRACT

A filter structure (100) for fuel fluids comprising a first filter wall and a hydrophobic wall, characterised in that the hydrophobic wall is made of a material having a mean static angle that is equal to or greater than 90°, a receding contact angle θ_{rec} that is less than 90° and a hysteresis H, between an advancing contact angle θₐᵥ and a receding contact angle θ_{rec}, that is comprised between 50° and 80°.

### TECHNICAL FIELD

The present invention relates to filtration of liquids such as fuel and lubricant, in particular liquids for supplying and lubricating internal combustion engines, in the following also referred-to simply as liquids.

Specifically, the invention relates to the need to eliminate the particles of water suspended in the fuel, which can cause damage to the mechanical organs of the engine, creating problems of oxidation and breakage thereof.

### PRIOR ART

This problem has been object of research for years, and is generally obviated by filter structures through which the fuel is transited, and which are generally made up by a first filter means which has the function of retaining the solid particles, by a second means which has coalescent properties and is able to collect the miniscule particles of water present in suspension in the fuel into droplets of larger dimensions, and by a third means generally having hydrophobic properties, which retains the particles or droplets of water previously collected, allowing only the fuel to pass through.

The particles or drops retained by the hydrophobic means slide by effect of gravity thereon and fall into the underlying collecting zone.

The means of the structure defined above are shaped as slim layers, which can be in reciprocal contact, or even at least partly spaced, and are generally conformed as concentric toroidal elements constituting the filter cartridge of a usual filter device.

At least the filter layer can have a pleated shape with a star-shaped section. The separation and elimination of the water in suspension obtained with the means of the prior art is however not suitable for responding to the ever-more stringent needs of engine manufacturers, for many reasons.

Firstly the pressure in the engine supply circuit tends to increase, and therefore the droplets of the water-fuel suspension are progressively smaller, assuming dimensions comparable to the pore dimensions or the dimensions of the fibres which make up the hydrophobic separators used.

Further, the progressively greater sophistication and precision of the mechanical organs destined to come into contact with the liquids has led to the need to eliminate even minimal quantities of water residues in suspension therein, making the known fuel filters inadequate.

The situation is made worse by the fact that the separation of the water is made more difficult by the presence of additives in the liquids, such as surfactants, which influence the interface tensions, reducing them and therefore making coalescence of the water particles in contact with the coalescing means difficult.

Lastly, in bio-fuels, the water is more rigidly bonded to the fuel; consequently, the separation thereof is more difficult.

The aim of the present invention is to disclose a structure able to obviate the above-delineated drawbacks with a solution that is effective, simple and relatively inexpensive.

This aim is attained by a filter structure having the characteristics listed in the independent claim, by a filter unit and by a fuel filter unit comprising the structure.

### DESCRIPTION OF THE INVENTION

An embodiment of the invention relates to filter structure for fuel fluids comprising a first filter wall and a hydrophobic wall, characterised in that the hydrophobic wall is made of a material having a static contact angle that is equal to or greater than 90°, a receding contact angle θ_{rec} of less than 90° and a hysteresis H, between an advancing contact angle θₐᵥ and a receding contact angle θ_{rec}, comprised between 50° and 80° (sexagesimal degrees). The receding contact angle can preferably be comprised between 50° and 80° (sexagesimal degrees).

The advancing contact angle θₐᵥ can advantageously preferably be comprised between 100° and 160° (sexagesimal degrees).

In the general definition, the wettability of a material relative to a liquid is defined simply as a function of a static contact angle θₛₜ, definable as a mean contact angle, on the basis of which materials having a static contact angle θₛₜ of greater than 90° are defined as hydrophobic and material having a static contact angle θₛₜ lower than 90° are defined as hydrophilic.

This angle, measurable using the appropriate techniques, macroscopically represents a mean of the various wettability conditions which are microscopically present on the surface of the material, due to the various conditions of surface energy present on the surface of the material and determined by the distribution of the micro-domains which form the surface structure of the material, or its coating.

The presence of these microdomains is particularly important in the case of polymer materials where the various structures making up the polymeric chain exhibit different energy states and thus various wettability conditions at local level. It is therefore possible to define a range of possible contact angles that can be encountered on a surface at microscopic level. Using the appropriate measuring systems (e.g. Wilhelmy scales or sessile drop or another known measuring system) it is possible to measure a receding contact angle θ_{rec}, representative of the microdomains with highest surface energy and thus more greatly hydrophilic (or less hydrophobic) and an advancing contact angle θₐᵥ representing microdomains having a lower surface energy and therefore more greatly hydrophobic (or less hydrophilic). In general, when a drop of water is static on the surface of a material the wettability of which is to be determined, the static contact angle θₛₜ, is the same in all directions, and it is the angle formed by the tangent to the drop with respect to the surface on the contact line between the drop and the surface, measured on the side of the drop.

Obviously the value of the static contact angle θₛₜ of a static drop is comprised between the value of the receding contact angle θ_{rec} and the value of the advancing contact angle θₐᵥ, i.e. the following relation is respected:

θ_{rec}<θₛₜ<θₐᵥ.

The hysteresis H of the contact angle is defined as the value calculated as the difference between the (measured) value of the advancing contact angle θₐᵥ and the (measured) value of the receding contact angle θ_{rec}, i.e. with the relation:

H=θₐᵥ−θ_{rec}

In the present embodiment of the invention the best results in terms of separation of the water from the fuel fluid are obtained when the material is generally hydrophobic, i.e. with a static contact angle θₛₜ of greater than 90°, the receding contact angle θ_{rec} is lower than 90° and the value of the hysteresis H is comprised between 50° and 80° (sexagesimal degrees).

The receding contact angle θ_{rec} can preferably be comprised between 50° and 80° (sexagesimal degrees).

The condition for which the receding angle θ_{rec} must be smaller than 90°, preferably comprised between 50° and 80°, is correlated to the state of surface energy of the fibres which make up the hydrophobic wall (or the covering applied, if applied) in which there is a coexistence of prevalently hydrophilic micro-domains (which combine to define the receding contact angle θ_{rec}) and prevalently hydrophobic microdomains (which combine to define the advancing contact angle θₐᵥ) which enable the drops to anchor to the fibre without extending along the fibres. The drops retained on the fibres of hydrophilic microdomains increase their size by coalescence with other drops and fall downwards by gravity.

Note that the extreme values of the indicated range are very different from the corresponding characteristic extreme values for the material of the hydrophobic wall most widely used in the prior art, in which the hysteresis value H is comprised in the following range: 10°<H<30° (sexagesimal degrees).

In particular, none of the prior art documents highlights the importance of the advantageous selection of the range of receding contact angle and hysteresis angle so as to determine an effective hydrophobic wall in separating the water even in critical conditions (e.g. in biofuels or fuels having a high surfactant content); emphasis is given, rather, to the selection of the hydrophobic wall on the basis of the single parameter defined by the static contact angle.

An example is given by document US 2008/0105629 (D2), in which the selection of the hydrophobic wall falls on a hydrophobic wall having a static contact angle comprised between 50° and 140° (sexagesimal degrees) and, in general, the definition of hydrophobic surfaces is given as a function of only the static contact angle (i.e. if the static contact angle is smaller than 90° it is defined as hydrophilic and if the static contact angle is greater than 90° the material is defined as hydrophobic).

Thanks to the characteristic specifications of the hysteresis of the material, it has been observed that the separation of the water from the fuel occurs at between 70 and 100%, for example even in fuels rich in surfactants and bio-fuels.

In a particular and preferred aspect of the invention, the hydrophobic wall is made of a material having a static contact angle of 110° (sexagesimal degrees), a receding contact angle (θ_{rec}) of 75° (sexagesimal degrees) and a hysteresis H, between an advancing contact angle θₐᵥ and a receding contact angle θ_{rec}, of 70° (sexagesimal degrees) and, therefore, an advancing contact θₐᵥ of substantially 145° (sexagesimal degrees).

A material having these characteristics guarantees 90% separation of the water from the fuel even in fuels rich in surfactants and bio-fuels.

In a further aspect of the first embodiment of the invention, the hydrophobic wall is realised in a material having a static contact angle θₛₜ that is comprised between 100° and 130° (sexagesimal degrees).

In a further aspect of the first embodiment of the invention, the hydrophobic wall is made of polyethylene terephthalate (PET) and/or polybutylene terephthalate (PBT).

A variant of the invention includes a further coalescent filter wall located downstream of and in contact with the first filter wall and upstream of the hydrophobic wall.

In an aspect of the first embodiment of the invention, the material of the coalescing filter wall is selected from among following materials: viscose, polyester, fibre glass.

A second embodiment of the invention makes available a filter cartridge for fuel fluids comprising an upper plate and a lower plate among which a filter structure is located comprising a first filter wall and a hydrophobic wall in which the hydrophobic wall is made of a material having a static contact angle equal to or greater than 90° (sexagesimal degrees), a receding contact angle θ_{rec} of lower than 90° (sexagesimal degrees) and a hysteresis H, between an advancing contact angle θₐᵥ and a receding contact angle θ_{rec}, comprised between 50° and 80° (sexagesimal degrees).

The receding contact angle θ_{rec} can preferably be comprised between 50° and 80° (sexagesimal degrees).

A third embodiment of the invention discloses a filter group for fuel fluids comprising an external casing, provided with an inlet conduit for the fuel to be filtered and an outlet conduit, for the filtered fluid, internally of which a filter cartridge is housed comprising an upper plate and a lower plate between which a filtering structure is located, comprising a first filter wall and a hydrophobic wall, in which the hydrophobic wall is realized in a material having a static contact angle equal to or greater than 90° (sexagesimal degrees) a receding contact angle of 90° (sexageismal degrees) and a hysteresis H, between an advancing contact angle and a receding contact angle θ_{rec}, comprised between 50° and 80° (sexagesimal degrees). The receding contact angle θ_{rec} can preferably be comprised between 50° and 80° (sexagesimal degrees).

### BRIEF DESCRIPTION OF THE DRAWINGS

The advantages and constructional and functional characteristics of the invention will emerge from the detailed description that follows, which with the aid of the accompanying tables of drawings illustrates some preferred embodiments of the invention by way of non-limiting example.

FIG. 1 is a section view of a first embodiment of a structure according to the invention.

FIG. 2 is a section view of a second embodiment of the structure according to the invention.

FIG. 3 is a section view of a filter group and a filter cartridge according to an embodiment of the invention.

### BEST WAY OF CARRYING OUT THE INVENTION

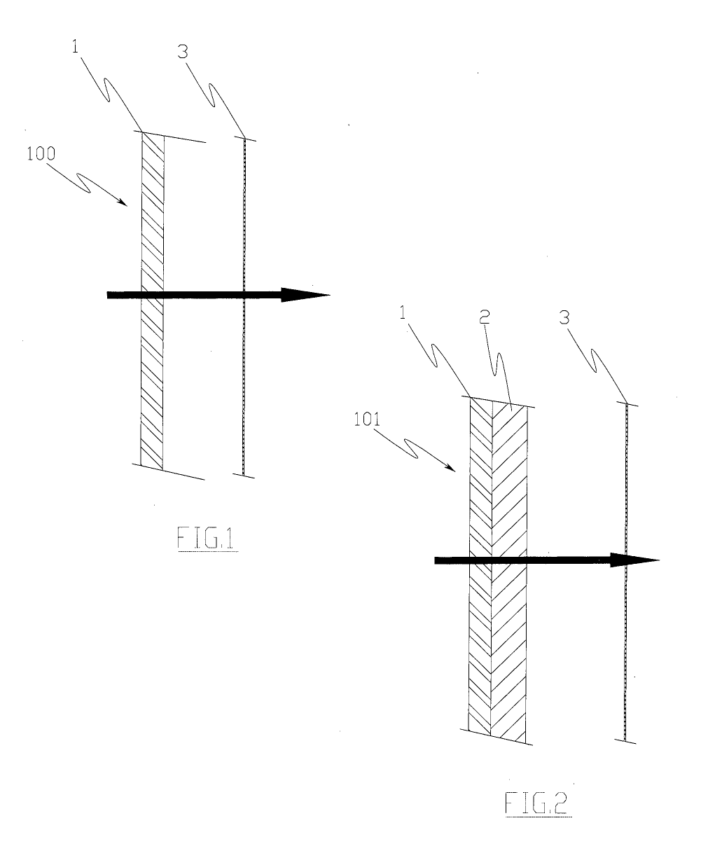

FIG. 1 shows an embodiment of the filter structure 100 and the water separator according to the invention.

The structure 100 comprises a first filter wall 1 for separating impurities from the fuel.

In the illustrated embodiment the first filter wall is made from polybutylene terephthalate, and has a porosity of 2-5 μm, a thickness of 0.5-0.7 mm, and a weight of 200 g/m².

In other embodiments of the invention the first filter wall can also be made of polyester or any other material suitable for the purpose.

A hydrophobic wall 3 is located downstream of the flow direction of fuel to be filtered, which hydrophobic wall 3 is able to provide a barrier against the water droplets that have collected while crossing the coalescing first filter wall 1.

The hydrophobic wall 3 is located at a certain distance from the coalescing second filter wall 1. Preferably, this distance varies from 0.1 mm to 20 mm depending on applications.

In a preferred embodiment, the hydrophobic wall 3 comprises a mesh or non-woven textile of fibres a surface of which is treated by means of a functionalisation treatment based on a hydrophobic material, for example based on fluorine and/or silicone, able to determine a predetermined surface energy state defined by values of θₐᵥ, θ_{rec} and by the hysteresis H (defined as the difference between θₐᵥ and θ_{rec}).

In an embodiment of the invention, the fibres can be made of nylon or coated polyester, by means of a usual functionalisation process based on fluorine and/or silicone. The treatment must be such as to determine the formation of microdomains on the surface (for example the surface of the hydrophobic wall 3 facing towards the first filter wall 1) of the fibres distributed so as to obtain hydrophobic material (with a static contact angle θₛₜ equal to or greater than 90°) having a receding contact angle θ_{rec}, comprised between 50° and 80° (sexagesimal degrees) and a hysteresis H, between an advancing contact angle θₐᵥ and a receding contact angle θ_{rec}, comprised between 50° and 80° (sexagesimal degrees).

In general, the hydrophobic material has a receding contact angle θ_{rec} of less than 90° (sexagesimal degrees).

For example, it is possible to obtain a hydrophobic wall 3, as described in the foregong, with a process for forming a hydrophobic wall 3 which has steps of:
arranging a wall, for example a mesh or a non-woven textile;
arranging a hydrophobic material, for example a functionalising substance comprising or constituted by silicone and/or fluorine.
applying the hydrophobic material to at least a surface of the wall, for example by means of immersion of the wall in a bath of functionalising hydrophobic material of a predetermined concentration for a determined immersion time or by exposure to a discharge of functionalising plasma of a predetermined concentration for a determined exposure time;
checking that the hydrophobic wall (3) obtained respects the required hydrophobic requisites, for example by means of the following control/selection sequence.

In practice, the control or selection of the hydrophobic wall 3 can include:
measuring a static contact angle θₛₜ of a hydrophobic wall 3, for example by means of a sessile drop or another known type measuring system;
measuring a receding contact angle θ_{rec} of a hydrophobic wall 3, for example by means of a Wilhelmy scales or a essile drop or another known type measuring system;
measuring an advancing contact angle θₐᵥ of a hydrophobic wall 3, for example by means of a Wilhelmy scales or a sessile drop or another known type measuring system; and
if the measured static contact angle θₛₜ is equal to or greater than 90°, the measured receding contact angle θ_{rec} is less than 90° and a hysteresis H, between the measured advancing contact angle θₐᵥ and the measured receding contact angle θ_{rec} is comprised between 50° and 80°, it is possible
to use the hydrophobic wall 3, i.e. associating it to a first filter wall 1 for realising a filter structure 100 for fuel fluids; and/or
to fix the composition of the functionalising substance used in the formation process and/or the other formation/functionalising process parameters (such as for example the application method of the functionalising substance, the immersion times and the plasma exposure times and eventually other parameters).

If on the other hand the measured static contact angle θₛₜ is less than 90°, and/or the measured receding contact angle θ_{rec} is greater than or equal to 90° and/or a hysteresis H, between the measured advancing contact angle θₐᵥ and the measured receding contact angle θ_{rec} is out of the above-mentioned range comprised between 50° and 80°, it is possible
to modify the composition of the functionalising substance used in the formation process and/or the other formation/functionalisation process (for example the application method of the functionalising substance, the immersion or plasma exposure times and eventually other parameters), and
to reiterate the control on a further hydrophobic wall 3 obtained with the formation/functionalising process with modified parameters, up until the condition is respected by which the measured static contact angle θₛₜ is equal to or greater than 90°, the measured receding contact angle θ_{rec} is less than 90° and a hysteresis H, between the measured advancing contact angle θₐᵥ, and the receding contact angle θ_{rec} is less than 90°, is comprised between 50° and 80°.

In a first embodiment the hydrophobic mesh 3 comprises (or is) a mesh made of polyethylene terephthalate (PET) with 600 threads per square inch, and exhibits a fluorine-based functionalised surface. A hydrophobic mesh with these characteristics exhibits a static equilibrium angle of 115° (sexagesimal degrees), a receding contact angle θ_{rec} of 65° (sexagesimal degrees) and a hysteresis H of 70° (sexagesimal degrees).

In this case, from tests carried out on a sample hydrophobic wall, a water separation from the fuel comprised between 70% and 100% has been observed, according to the dimensions of the drops dispersed in the diesel.

In a second embodiment the hydrophobic mesh 3 comprises (or is) a mesh made of polyethylene terephthalate (PET) with 450 threads per square inch, and exhibits a fluorine-based functionalised surface. A hydrophobic mesh with these characteristics exhibits a static equilibrium angle of 120° (sexagesimal degrees), a receding contact angle θ_{rec} of 80° (sexagesimal degrees) and a hysteresis H of 60° (sexagesimal degrees).

In this case, from tests carried out on a sample hydrophobic wall, a water separation from the fuel comprised between 80% and 100% has been observed, according to the dimensions of the drops dispersed in the diesel.

In a third embodiment the hydrophobic wall comprises (or is) a non-woven textile made of a synthetic material produced by a melt-blown product (for example polyester or nylon) so as to have a pore dimension comprised between 2 and 20 micron (preferably comprised between 3 and 5 micron) with a fluorine-based functionalised surface. A hydrophobic mesh with these characteristics exhibits a static equilibrium angle of 115° (sexagesimal degrees), a receding contact angle θ_{rec} of 55° (sexagesimal degrees) and a hysteresis H of 80° (sexagesimal degrees).

In this case, from tests carried out on a sample hydrophobic wall, reaching a water separation from the fuel comprised between 90% and 100% has been observed, according to the dimensions of the drops dispersed in the diesel.

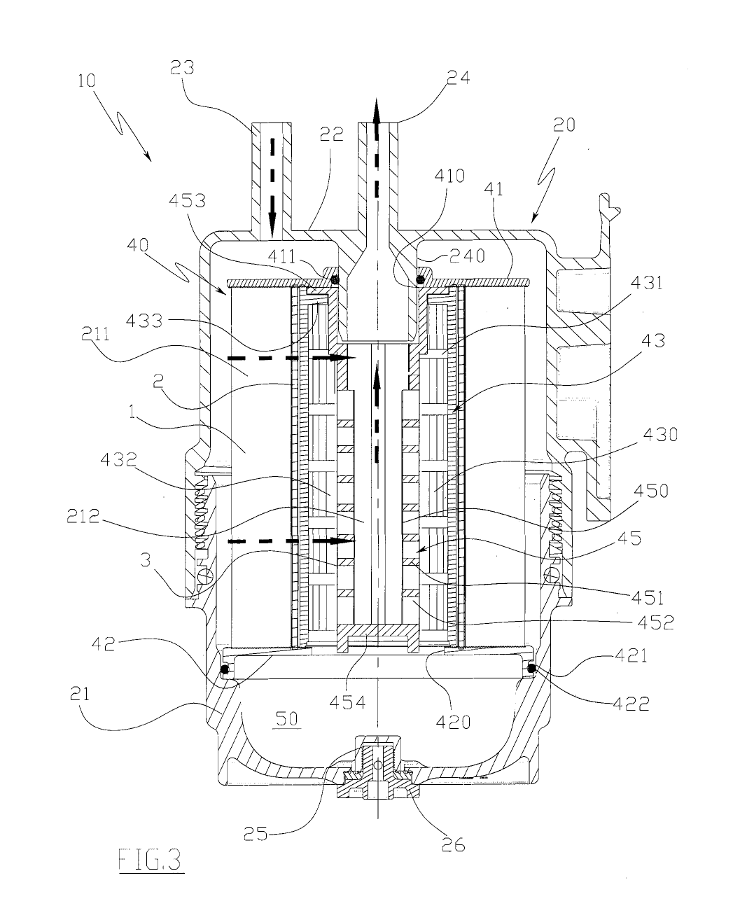

FIG. 2 illustrates a second embodiment of a filter structure 101 for separating water according to the invention.

In the description of the water-filtering and separating structure 101 the same reference numerals will be used for denoting the components that are identical to those already described in the first structure 100.

The structure 101 comprises a first filter wall 1 for separating impurities from the fuel.

A coalescing second filter wall 2 is positioned downstream of the flow direction of the fuel to be treated and in contact with the first filter wall 1.

The coalescing second filter wall 2 can be made of a coalescent material exhibiting a known structure and a composition, i.e. one that is able to obtain the coalescent effect in relation to water particles present in the fluid fuel to be filtered.

For example, the second filter wall 2 can be made of viscose, polyester, glass fibre, single-component fibre, bi-component fibre and/or bi-constituents.

In general, in accordance with the invention the coalescing second filter wall 2 must exhibit a greater porosity than the first filter wall 1. Further, in a preferred embodiment, the coalescing second filter wall 2 has a greater thickness than the first filter wall 1.

A hydrophobic wall 3 is located separately and downstream of the second filter wall 2, which hydrophobic wall 3 is able to provide a barrier against the water droplets that have collected while crossing the coalescing second filter wall 2.

The hydrophobic wall is subjected to a functionalising surface treatment such as to determine a static contact angle that is equal to or greater than 90° having a receding contact angle θ_{rec}, of less than 90° (sexagesimal degrees) and preferably comprised between 50° and 80°, and a hysteresis H, between an advancing contact angle θₐᵥ and a receding contact angle θ_{rec}, comprised between 50° and 80° (sexagesimal degrees).

The structures 100 and/or 101 are applicable in filter cartridges destined to be used internally of groups for fluid filtration, in particular for filtering fuels supplying internal combustion engines.

FIG. 3 illustrates the structure 101 associated to a filter cartridge 40 which is used internally of a filter group 10 for filtering the fuel of an internal combustion engine.

The filter assembly 10 comprises an external casing, denoted in its entirety by 20, provided with an inlet conduit 23 for the fuel to be filtered and an outlet conduit 24 for the filtered fuel.

In the illustrated embodiment the casing 20 comprises a cup-shaped body 21, and a cover 22 able to close the cup-shaped body 21, on which the inlet conduit 23 for the fuel filter and the outlet conduit 24, which is axial, for the filtered fuel are located.

The cup-shaped body 21 comprises, positioned at a bottom thereof, a discharge conduit 25 for the water that accumulates on the bottom of the cup-shaped body 21, provided with a closure cap 26.

The filter cartridge 40 is accommodated internally of the casing 20, which filter cartridge 40 divides the internal volume of the casing 20 into two distinct chambers 211, 212, of which a first chamber 211 for the fuel to be filtered (in the example external), in communication with the inlet conduit 23, and a second chamber 212 of the filtered fuel (in the example internal), in communication with the outlet conduit 24.

The filter cartridge 40 comprises an upper support plate 41 and a lower support plate 42 between which the previously-described filter structure 101 is located.

The upper support plate 41 is substantially disc-shaped and affords a central hole 410 centred on the longitudinal axis A of the filter cartridge 40.

The lower support plate 42 is also substantially disc-shaped and has a central hole 420 centred on the longitudinal axis A of the filter wall 43.

The central hole 410 of the upper support plate 41 inserts on an internal end portion of the outlet conduit 24, with the interposing of a usual seal ring 411 fixed in a suitable seating at the central hole 410.

The lower support plate 42, instead, enters and rests on the bottom of a cylindrical annular seating 421 afforded in the vicinity of the bottom of the cup-shaped body 21 (at a distance therefrom) by interposing of a further seal ring 422.

In the present embodiment, the first filter wall 1 and the coalescing second wall 2 are realized as loop-closed pleated walls, i.e. exhibiting, in horizontal section, a known star-shape.

The first filter wall 1 and the coalescing second filter wall 2 are inserted externally of a cylindrical core 43 that connects the first and the second plate. The core 43 exhibits a cage-like structure of substantially tubular shape and a diameter substantially equal to (or slightly smaller than) the internal diameter of the coalescing second filter wall 2.

In particular, the cage structure of the core 43 is constituted by a plurality of vertical uprights 430 (e.g. equidistant) which join a plurality of horizontal rings 431 (for example, equidistant) defining the openings 432 for the passage of the fluid.

The opposite ends of the second longitudinal core 43 are both open and possibly respectively fastened, for example by gluing or welding, to the mutually facing internal faces respectively of the upper support plate 41 and the lower support plate 42.

A second core 45 is housed internally of the core 43, coaxial to the first core 43 and having a cage-like structure exhibiting a substantially tubular shape and a diameter that is smaller than the diameter of the first core 43.

In particular, the cage structure of the second core 45 is constituted by a plurality of vertical uprights 450 (e.g. equidistant) which join a plurality of horizontal rings 451 (for example, equidistant) defining the openings 452 for the passage of the fluid.

The hydrophobic filter 3 of the filter structure 100 is inserted on the external surface of the second core 45.

In other embodiments of the invention the hydrophobic wall 3 can be associated to the external or internal surface of the second core 45 by means of a method of any known type, for example by gluing or co-moulding.

The upper end of the second core 45 is inserted into an internal extension 240 of the discharge conduit 24 and exhibits at an edge thereof a flange 453, a lower surface of which rests against an annular shelf 433 that branches internally from the first core 43. With this configuration, the flange 453 of the core is clamped between the annular shelf 433 and the upper plate 41.

The lower end of the second core 45 is, instead, closed by a disc-shaped body 454 located at the central hole of the lower plate 42.

In the light of the foregoing, the operation of the filter assembly 10 is evident.

The flow of fuel to be treated moves from the periphery towards the centre of the filter assembly 10.

The fuel passes through the first filter wall 1, which, thanks to its low porosity, separates the impurities from the fluid.

Subsequently, the fluid (fuel and water particles) passes through the coalescing second filter wall 2, which by virtue of the coalescing effect collects the water particles to form larger-size drops. The drops of collected water are blocked by the hydrophobic wall 3, which instead allow the filtered fuel to pass through, which filtered fuel is then directed towards the outlet conduit 24.

The drops of water blocked by the hydrophobic fall by effect of gravity into a lower collecting chamber superiorly delimited by the lower plate 42, and from there are discharged through the discharge hole 25.

The invention as it is conceived is susceptible to numerous modifications and variants, all falling within the scope of the inventive concept.

Further, all the details can be replaced by other technically-equivalent elements.

In practice, the materials used, as well as the contingent shapes and dimensions, can be any according to requirements, without forsaking the scope of protection of the following claims.

1. A filter structure (100) for fuel fluids comprising a first filter wall (1) and a hydrophobic wall (3), wherein the hydrophobic wall (3) has a static contact angle θₛₜ that is equal to or greater than 90°, a receding contact angle θ_{rec} of less than 90° and a hysteresis H, between an advancing contact angle θₐᵥ and the receding contact angle θ_{rec}, between 50° and 80°.

2. The filter structure of claim 1, wherein the hydrophobic wall (3) has a receding contact angle θ_{rec}, between 50° and 80°.

3. The filter structure of claim 1, wherein the hydrophobic wall (3) comprises a mesh or non-woven textile a surface of which, facing the first filter wall (1), has a functionalizing treatment made of a hydrophobic material.

4. The filter structure of claim 3, wherein the hydrophobic material is fluorine or silicone.

5. The filter structure of claim 3, wherein the functionalizing treatment is constituted by an application on the surface of the mesh or non-woven textile of the hydrophobic material in micro-domains distributed on the surface.

6. The filter structure of claim 1, wherein the hydrophobic wall (3) has a static contact angle θₛₜ of 110°, a receding contact angle θ_{rec} of 65° and a hysteresis H, between an advancing contact angle θₐᵥ and a receding contact angle θ_{rec}, of 70°.

7. The filter structure of claim 1, wherein the hydrophobic wall (3) has a static contact angle θ_{rec} between 100° and 130°.

8. The filter structure of claim 1, wherein the hydrophobic wall (3) is made of at least one of polyethylene terephthalate (PET) or polybutylene terephthalate (PBT).

9. The filter structure of claim 1, further comprising a coalescing filter wall (2) located downstream of and in contact with the first filter wall and upstream of the hydrophobic wall.

10. The filter structure of claim 9, wherein the material of the coalescent filter wall (2) is selected from among following materials: viscose, polyester, fibre glass.

11. A filter structure (40) for fuel comprising an upper plate (41) and a lower plate (42) between which a filter structure (100) for fuel fluids is positioned, the filter structure (100) comprising a first filter wall (1) and a hydrophobic wall (3), wherein the hydrophobic wall (3) has a static contact angle θₛₜ that is equal to or greater than 90°, a receding contact angle θ_{rec} that is less than 90° and a hysteresis H, between an advancing contact angle and a receding contact angle θ_{rec}, between 50° and 80°.

12. The filter cartridge of claim 11, comprising a filter structure according to claim 1.

13. A filter group (10) comprising an external casing (20), provided with an inlet conduit (23) for fluid to be filtered and an outlet conduit (24), for the filtered fluid, an interior of the filter group (10) configured to house a filter cartridge (40) claim 11.

14. A selection method of a hydrophobic wall (3) for using the wall (3) in separation of water from a fuel fluid comprising the steps of:
measuring a static contact angle θₛₜ of a hydrophobic wall (3);
measuring a receding contact angle θ_{rec} of the hydrophobic wall (3);
measuring an advancing contact angle θ_{avV} of the hydrophobic wall (3);
associating the hydrophobic wall (3) to a first filter wall (1) for realizing a filter structure (100) for fuel fluids, if the measured static contact angle θₛₜ is equal to or greater than 90°, the measured receding contact angle θ_{rec} is less than 90° and a hysteresis H, between the measured advancing contact angle θₐᵥ and the measured receding contact angle θ_{rec} that is between 50° and 80°.

15. A process for forming a hydrophobic wall (3) comprising the steps of:
arranging a wall to be made hydrophobic;
arranging a hydrophobic material;
applying the hydrophobic material to at least a surface of the wall;
checking that the hydrophobic wall (3) obtained respects the required hydrophobic requisites by means of the selection method of claim 14.

16. The filter structure of claim 4, wherein the functionalizing treatment is constituted by an application on the surface of the mesh or non-woven textile of the hydrophobic material in micro-domains distributed on the surface.
